(19) United States
(12) Patent Application Publication
(10) Pub. No.: US 2026/0220188 A1
(43) Pub. Date: Jul. 30, 2026

(54) SYSTEMS AND METHODS FOR DIGITAL MEDIA CREATION WITH AUTOMATED FILE MANAGEMENT

(71) Applicant: Nishant Shah, Aurora, IL (US)

(72) Inventor: Nishant Shah, Aurora, IL (US)

(21) Appl. No.: 19/578,624

(22) Filed: Mar. 25, 2026

Related U.S. Application Data
(63) Continuation-in-part of application No. 19/337,099, filed on Sep. 23, 2025.
Application No. 19/337,099 is a continuation-in-part of application No. 18/970,886, filed on Dec. 5, 2024, now Pat. No. 12,452,526.

(51) Int. Cl. G06F 16/40; G06F 12/06

(52) U.S. Cl. CPC G06F 16/40; G06F 12/06

(57) ABSTRACT

A mobile app based digital media recording system that includes a file organization system defining albums, where each album can contain digital media files, and each digital media file in the album inherits an album name of the album as a portion of its filename stem. When a file is moved from one album to another, the album name portion of its filename stem is changed to the album name of the destination album. Similarly, when an album name is edited, the album name portion of the filename stem of each digital file contained in the album is changed to the edited album name. When a digital file is copied or exported to a storage location outside the file organization system, or otherwise without being added to a different album, the file retains the name of the album of origin in its filename stem.

### CROSS REFERENCE

This application is a continuation in part of U.S. patent application Ser. No. 19/337,099, filed Sep. 23, 2025, and entitled SYSTEMS AND METHODS FOR DIGITAL MEDIA CREATION WITH AUTOMATED FILE MANAGEMENT, which is a continuation in part of U.S. patent application Ser. No. 18/970,886, filed Dec. 5, 2024 and entitled SYSTEMS AND METHODS FOR DIGITAL MEDIA CREATION WITH AUTOMATED FILE MANAGEMENT, each of which is hereby incorporated by reference in its entirety

### FIELD OF THE DISCLOSURE

The present disclosure relates to electronic media file creation and management systems and methods, and more particularly, to systems and methods for recording, organizing, customizing, and editing visual and audiovisual media.

### BACKGROUND

Since the advent of smartphones, with built-in cameras and access to practically limitless internal and/or remote networked (“cloud”) data storage, it has become increasingly easy and convenient for a person or organization to amass daunting numbers of digital media files, particularly videos and photos. So much so that organizing one's digital media library is often a daunting task that users often undertake sporadically and haphazardly, if at all. Some users create folders intended to store media files associated with places, people or events, often forgetting that a folder associated with a particular event already exists, and/or neglecting to store files in a folder intended for those files. Later, the users waste time browsing or searching empty or underutilized folders in search of the files they meant to store in those folders, which are either in another redundant folder or in an uncategorized default storage location, where the bulk of the user's files may typically end up. Other users opt to forgo organization completely, leaving entire libraries of videos and photos captured by their cameras in a single default system folder, requiring those users to browse through a large number of ungrouped files, in search of a particular file, or chronologically scattered files related to a particular subject.

Accordingly, a need exists for systems and methods for media file creation that facilitate organization of the files into folders by subject matter, while avoiding or reducing the occurrence of unused and/or redundant folders.

### SUMMARY

According to an aspect of the disclosure a digital media file recording and organization system comprises a recording component, a processor, a storage, a software application, and a display. The recording component is operative to record audiovisual content comprising at least one of images and sound, to generate digital media data from the recorded audiovisual content, the digital media data comprising at least one of digital image data representing recorded images and digital audio data representing recorded sound. The processor is operatively connected to the recording component to read the digital media data from the recording component. The storage comprises a non-volatile computer-readable medium adapted and configured to store a plurality of digital media files, each digital media file comprising at least a portion of the digital media data read from the recording component, the processor being operatively connected to the storage to write the digital media files to the storage and to read the digital media files from the storage. The software application comprises computer readable instructions stored in the storage, the processor being operative to read and execute the instructions from the storage. The processor is operatively connected to the display, the software application including instructions for the processor to display a user interface on the display. The user interface comprises interactive user interface views, and the display comprises a touchscreen, the touchscreen being operative to detect user touch inputs and to generate user input data from the user touch inputs, the processor being operatively connected to the touchscreen to read the user input data from the touchscreen. The software application includes instructions for the processor to display a recording interface on the display, the recording interface comprising a record control and a file navigation link. The software application further includes instructions for the processor to:
activate the recording component to begin recording said audiovisual content to generate said digital media data when the record control is activated a first time by a user touch input on the touchscreen, and when the record control is so activated a second time, stop said recording and write to the storage a digital media file containing the digital media data generated during said recording;
display a file navigation interface on the display when the file navigation link is activated, the file navigation interface including at least an album listing view, the album listing view displaying a plurality of album areas representing a corresponding plurality of albums, each of the albums being a logical entity stored in the storage, the logical entity being configured to logically contain zero or more of the digital media files stored in the storage;
delete any empty album, that is, an album that contains no digital media files, subject to one or more further conditions for the deletion of an empty album.

### BRIEF DESCRIPTION OF THE DRAWINGS

Although the characteristic features of this disclosure will be particularly pointed out in the claims, the disclosed method and system, and how it may be made and used, may be better understood by referring to the following description taken in connection with the accompanying drawings forming a part hereof, wherein like reference numerals refer to like parts throughout the several views and in which:

FIG. 1 is a simplified block diagram of a system for digital media creation and file management according to an embodiment.

FIG. 2 is a camera mode view of a user interface for the system of FIG. 1.

FIG. 3 is another camera mode view of a user interface for the system of FIG. 1.

FIG. 4 is a pin time selection menu view of a user interface for the system of FIG. 1.

FIG. 5 is another camera mode view of a user interface for the system of FIG. 1.

FIG. 6 is another camera mode view of a user interface for the system of FIG. 1.

FIG. 7 is another camera mode view of a user interface for the system of FIG. 1.

FIG. 8 is a file navigation album listing view of a user interface for the system of FIG. 1.

FIG. 9 is a file navigation album detail view of a user interface for the system of FIG. 1.

FIG. 9A is an event content import view of a user interface for the system of FIG. 1.

FIG. 10 is another camera mode view of a user interface for the system of FIG. 1.

FIG. 11 is an album listing view of another embodiment of a user interface for the system of FIG. 1.

FIG. 11A is an album listing and pin time selection panel view of a user interface for the system of FIG. 1 embodied as in FIG. 11.

FIG. 12 is a simplified flow diagram of a method of file management using the system of FIG. 1.

FIG. 13 is another camera mode view of a user interface for the system of FIG. 1 according to an embodiment.

FIG. 14 is another camera mode view of the user interface according to the embodiment of FIG. 13.

FIG. 15 is an overlay options menu view of the user interface according to the embodiment of FIG. 13.

FIG. 16 is another camera mode view of the user interface according to the embodiment of FIG. 13.

FIG. 17 is an album listing view of the user interface according to the embodiment of FIG. 13.

FIG. 18 is another camera mode view of the user interface according to the embodiment of FIG. 13.

FIG. 19 is an album detail view of the user interface according to the embodiment of FIG. 13.

FIG. 20 is another overlay options menu view of the user interface according to the embodiment of FIG. 13.

A person of ordinary skill in the art will appreciate that elements of the figures above are illustrated for simplicity and clarity and are not necessarily drawn to scale. The dimensions of some elements in the figures may have been exaggerated relative to other elements to help to understand the present teachings. Furthermore, a particular order in which certain elements, parts, components, modules, steps, actions, events and/or processes are described or illustrated may not be required. A person of ordinary skill in the art will appreciate that, for simplicity and clarity of illustration, some commonly known and well-understood elements that are useful and/or necessary in a commercially feasible embodiment may not be depicted to provide a clear view of various embodiments per the present teachings.

### DETAILED DESCRIPTION

In the following description of exemplary systems and methods embodying aspects of the disclosure, reference is made to the accompanying drawings, which form a part hereof, and in which are shown by way of illustration various example devices, systems, and environments in which aspects of the disclosed system and method can be practiced. Other specific arrangements of parts, example devices, systems, and environments, can be used, and structural modifications and functional modifications can be made without departing from the scope of the disclosed system and method.

Disclosed herein are systems and methods for integrated electronic file creation and organization. More particularly, in the embodiments described and illustrated herein, the electronic files are digital media files (photos and videos, with or without sound). The systems and methods are typically implemented by a software application, “app,” or where applicable “mobile app,” executed on an electronic computing system (typically that of a smartphone), which is operatively connected to a video camera (or “camera”). The computing system includes a processor, a memory, a user output device (which is shown as a display in the illustrated embodiments but may be or also include a speaker) and a user input device (shown as a touchscreen, but may be or also include a microphone and/or hard buttons). The camera includes a lens, an image sensor, and a video processor. The computing system and the camera can be integrated into a single housing or enclosure, such as that of a smartphone or other small, handheld electronic device. However, it should be understood that the principles of the interface can easily be used on other types of devices as well, such as digital camcorders, digital cameras, or remote-control software operating on a computer or other device to control a remotely located camera, which comprises at least lens and a sensor located in a separate enclosure from the computer.

### Physical System Components

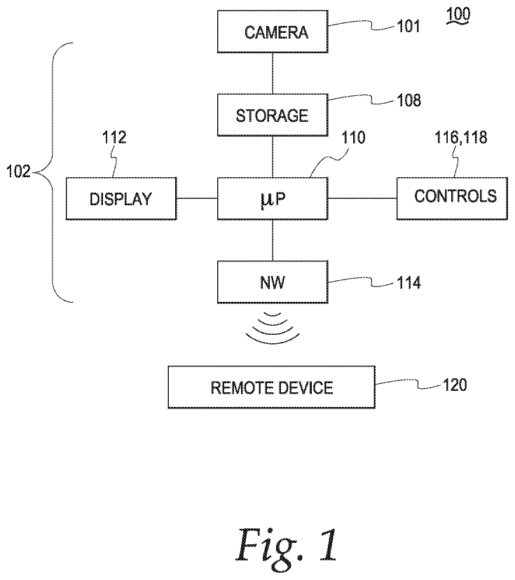

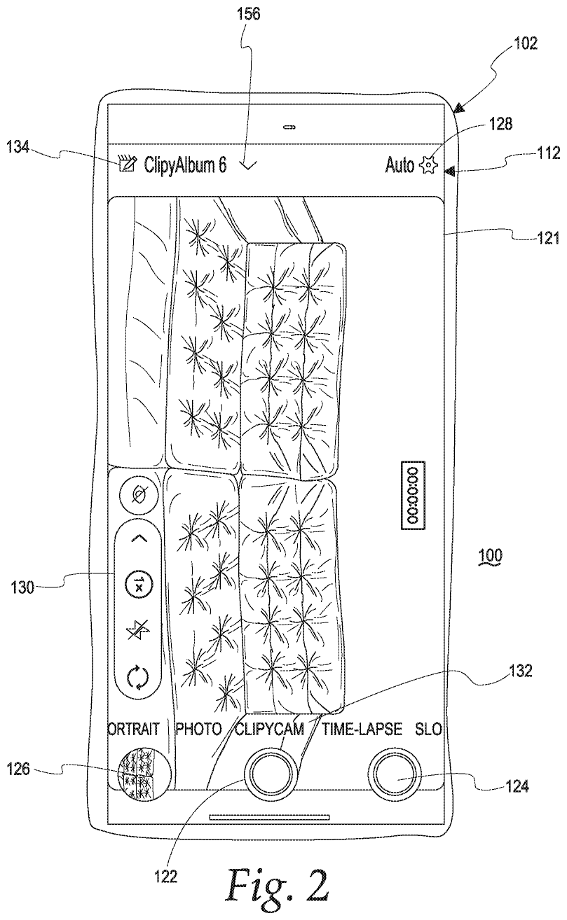

Shown in FIG. 1 is a simplified block diagram illustrating the general construction of a recording and file management system 100 according to embodiments of the disclosure. The recording system 100 includes a recording component 101 (which is depicted as a “CAMERA” block and is alternately referred to herein as a camera 101, but which can instead or additionally comprise a microphone), which typically comprises a camera including at least an image sensor and a lens that focuses light on the image sensor; a storage 108, a processor 110, a display 112, controls including manual controls 116 and automatic controls 118, a network interface 114, and optionally a remote device 120. In embodiments, the camera 101, storage 108, processor 110, display 112, controls 116 and 118, and network interface 114 are comprised in a recording device 102 (alternately referred to as a camera device 102, as depicted in FIGS. 2-11). Typically, the output of an image sensor will be processed by a video processor (which may be the central processor of an electronic device that includes the camera, or it may be a separate video processor, such as the processor 110), which will process the video from the image sensor and write or commit full frames of video to storage 108. The video processor may process data from the image sensor at a frame rate. In embodiments, a video processor that is separate from the processor 110 writes frame data directly to storage 108 via a DMA channel. In other embodiments, the processor 110 reads data from the video processor (or directly from the image sensor, in which case a video processor can be omitted) and writes the frame data to storage 108.

The storage 108 used by the recording system 100 can be any suitable type of non-volatile memory device, having a write speed that is sufficient for the frame rate at which the recording system 100 is operated.

During recording of video, the processor 110 reads frame data from storage 108 or directly from an image sensor or video processor of the camera 101 and displays it in real time on the display 112. The processor 110 also performs housekeeping activities, such as configuring the video processor if any, accepting manual controls 116 and automatic controls 118, and interfacing with one or more remote devices 120 via the network interface 114.

The display 112 can be, for example, a Liquid Crystal Display (LCD), an LED or an OLED display, or another type of display, and is of sufficient resolution and refresh rate for the video camera operator to view and monitor the scene that is being recorded. In certain implementations, the display 112 can be a touchscreen.

As mentioned above, controls of the recording system 100 can include both manual controls 116 and automatic controls 118. Manual controls 116 are components that receive and transmit manual user inputs to the processor 110, while automatic controls 118 are components that automatically generate and transmit inputs to the processor 110.

Manual user inputs to the processor 110 allow the camera operator to control the operation of the recording system 100. The manual controls 116 can include, for example, a touch screen system, or a collection of buttons, sliders, joysticks, gesture controls, voice controls, and other input control components, as are typical in video camera systems.

The automatic controls 118 transmit inputs automatically to the processor 110, such as geolocation and user activity, as described below. The automatic controls 118 can include, for example, a geolocation component operative to determine the geolocation of a camera device 102, such as a GPS component retained by the camera device 102, a clock, and/or one or more sensors such as a light sensor and/or a motion sensor retained by the camera device 102. For purposes of this disclosure, where not stated otherwise, a “camera device” includes at least a camera, comprising such components as are commonly understood to be required to be present at or near the location of the subject(s) of the image frames captured in a photograph or video recording. More particularly, a camera includes at least a lens and a sensor. The lens and sensor are understood to be coupled to a processor, be it a video processor or a more general-purpose central processor of a multi-purpose electronic device that includes a camera and other components. In the illustrated embodiment depicted schematically in FIG. 1, in addition to the camera 101, the camera device 102 further includes the storage device 108, the processor 110, the display 112, the manual controls 116, the automatic controls 118, and the network interface 114. In other embodiments, any of the latter group of components can be remotely coupled to a camera device.

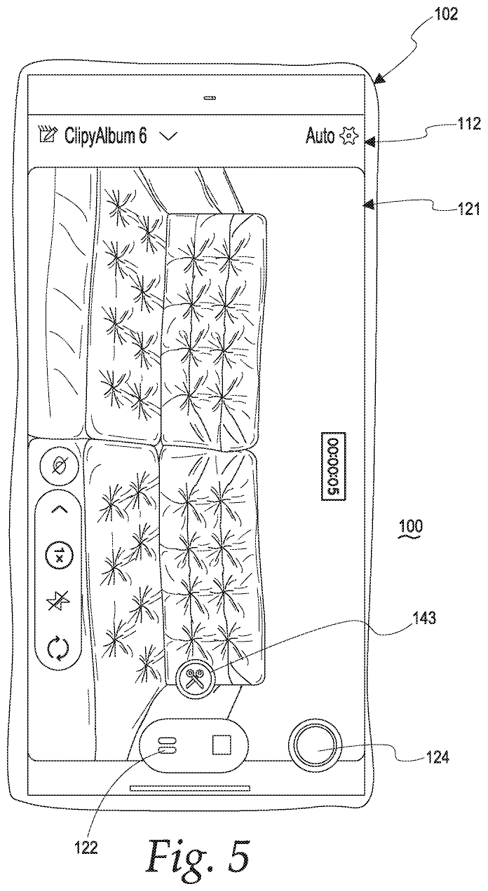

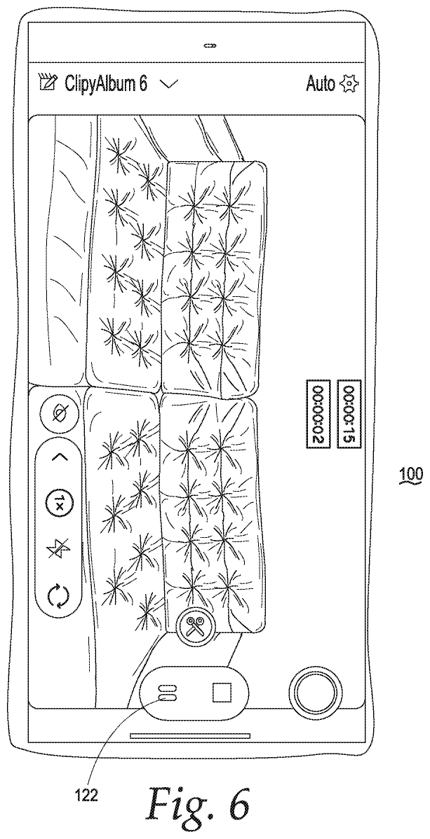

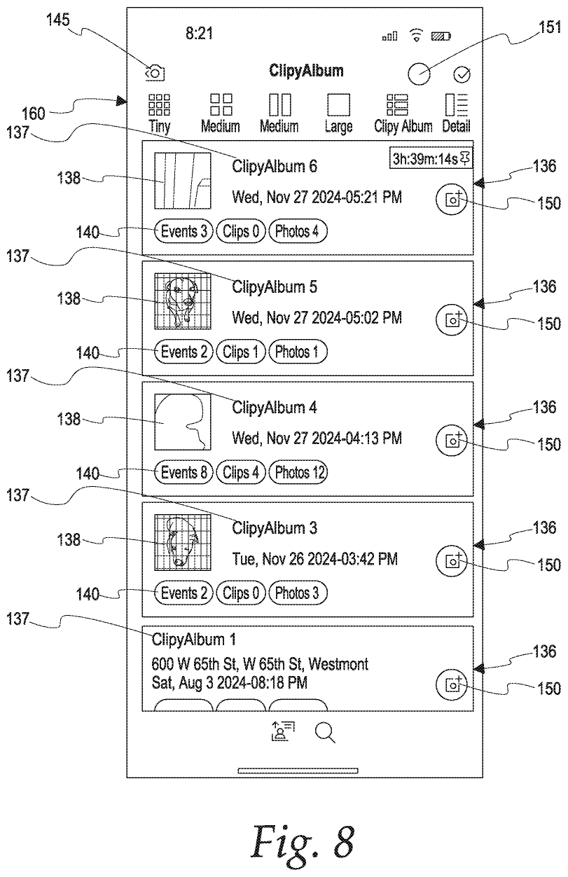

Turning to FIGS. 2-11, various views or screens of an exemplary interface for the camera operator are disclosed, as displayed on the display 112 of the camera device 102, which in the illustrated embodiment is a touchscreen display. When a camera mode is activated, the interface displays in a digital viewfinder 121 a live scene captured by the camera 101, where a “live scene” will be understood to be a most recent still image captured by the camera. The exemplary interface also includes a number of touch controls. A record/stop control 122 (also interchangeably referred to herein as the record control 122 or the stop control 122 in applicable contexts) is shown as a “button” image in an actuatable area of the touchscreen display 112, which can toggle between displaying a standard circle symbol commonly associated with recording, when no recording is in progress, and a standard square symbol commonly associated with stopping a recording, when a recording is in progress. When the “record” circle is displayed, as in FIG. 2, a user activating the record control 122 initiates a recording, and when the “stop” square is displayed (e.g., FIGS. 5-6), a user activating the stop control 122 stops a recording and commits to storage a physical main stream of video data that was captured between the previous two activations of the record/stop control 122. It should be understood that other embodiments within the scope of the disclosed system and method can represent a record/stop control and its states in many different ways, and still others can use a dedicated record control and a separate stop control. Additional controls displayed in the exemplary interface as shown in FIG. 2 include a snap control 124, displayed as a button icon, which creates a digital still image (photo) file of the live scene when activated by a user; a file navigation link 126, displayed as a thumbnail of the most recently captured video frame or still image, which causes a file navigation or gallery interface to be displayed when activated (as shown in FIGS. 8, 9, 9A, 11, and 11A and described in more detail further below); a settings control 128, displayed as a familiar gear icon, which opens a settings menu when activated; an expandable and collapsible toolbar 130 including a number of tool selection controls represented by individual icons, as described in detail in U.S. patent application Ser. No. 18/903,435, the entire disclosure of which is hereby incorporated by reference herein; a mode-selection ribbon 132, displayed as scrollable ribbon of text, which allows a user to toggle between various camera modes, by either swiping the ribbon to the left or right until the name of the desired mode is centered in the viewfinder 121 or by tapping the name of any desired mode that appears in the window; an edit event info control 133; and a pinned album indicator 134, the latter two controls relating to an album-management aspect of the system 100 described further below.

It should be noted that systems illustrated herein can be utilized with camera systems (or smartphone, tablet, and other systems) that utilize multiple cameras or multiple lenses. For example, it is known in the art to record from multiple cameras or lenses simultaneously; for example, a wide-angle camera or lens can be used to record an entire scene (such as an entire stage), while a zoom camera or lens can be used to record the center of a scene (such as a part of the stage where the action is).

It should be noted that certain embodiments may not include all of the components illustrated in FIG. 1 and described above. For example, a “screen recorder” implementation of the disclosed recording system 100 (which could be used for teleconferencing, for example) would not require a lens, an image sensor, or a video processor. In such embodiments, the processor 110 or other suitable processor can be instructed to read each of a series of digital image data frames from a digital video data stream as the corresponding digital image frame is displayed on, or just before it is sent to, a system display (such as a computer monitor or the integrated display screen of a laptop, smartphone, or other electronic device), write the series of digital image data frames to storage as a digital video data stream, and use the digital video data stream in the same ways as described for any embodiment of the disclosure. For example, instead of reading digital image data frames from the image sensor or video processor of a camera, or from locations in the storage 108 where the video processor has written them, the processor 110 can read each digital image data frame from a graphics card (not shown) just before the frame is sent to a display. More particularly, the software of the system 100 may request the digital image data frames from a device operating system (OS), which can grant the request by allowing the processor 110 to read each digital image data frame and pass it to the system software, just before it is sent to the display. This can allow the OS to refuse to permit an app to record a screen where content with digital rights management (DRM) protections is playing. In addition, some embodiments may not require a network interface 114. Other embodiments may similarly not require other components. For example, the network interface 114 can interface directly with the video processor and even the image sensor, so that video can be directly streamed to a remote device 120 via the network interface 114. In addition, certain other components, such as a microphone for recording audio either concurrently/synchronized with or independently of video, may be present in the recording system 100 but have been omitted for brevity and clarity.

In other embodiments, the components of the recording device 102, that is, the recording component (e.g., a camera) 101, storage 108, processor 110, display 112, controls 116, 118, and/or network interface 114 can be distributed among multiple physically separate devices that are operatively connected, via wired or wireless connections, so as to enable such components interact with one another in the same ways as described herein for corresponding components of a single device. For example, a first device such as smartphone, tablet, or laptop computer may comprise the display 112, controls 116, 118, and network interface 114 of the system 100, while the camera 101, storage 108 or some portion thereof, and/or the processor 110, may reside in one or more remote devices 120, which may for example include a cloud server connected to the first device, another device of the same type connected to the first device via a local area network or peer-to-peer connection, or a standalone storage device connected in any such manner to the first device. In other examples, the camera or recording component 101 may reside in a wearable device such as glasses, a watch, a helmet cam or body cam (such as available under the mark GoPro® or DJI®), in a mechanical device with self-propelled movement, such as a drone or other air, land, or water vehicle, a robot (for example, an assembly line robot, a surgical robot, or a personal-assistant robot), a gantry, or an elevator or lift system. The camera or recording component 101 can come in compact or ultra-compact form factors, down to smaller than a user's thumb. It can function as a security camera or operating-room black-box camera, or a web cam such as used in teleconferencing or online streaming.

### Album Management

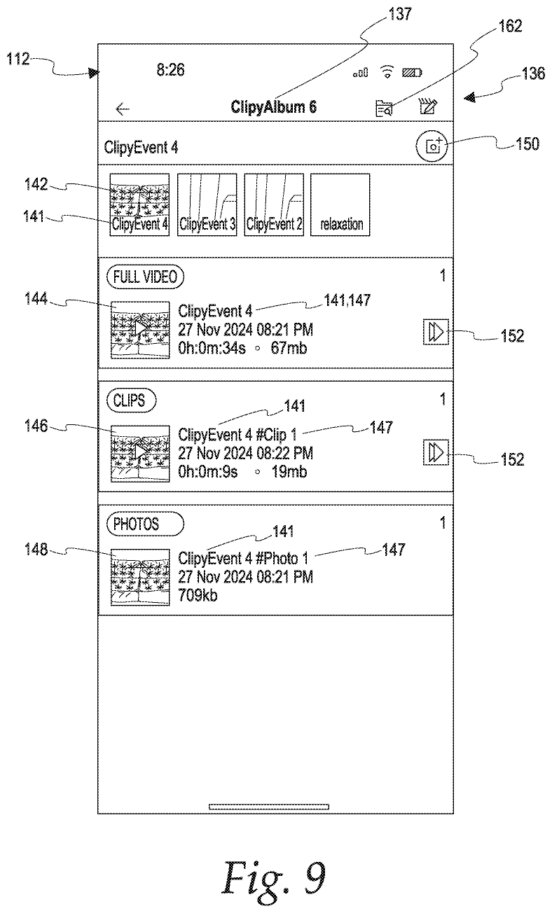

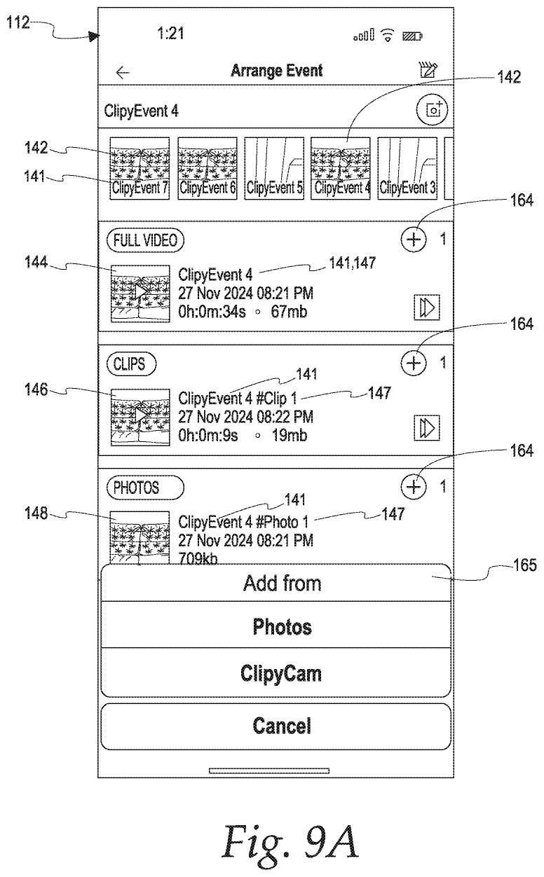

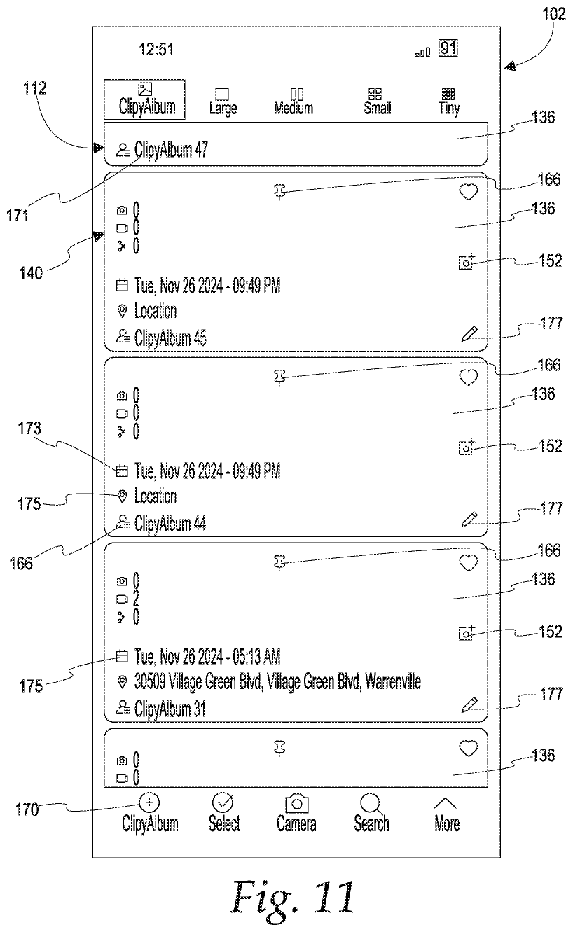

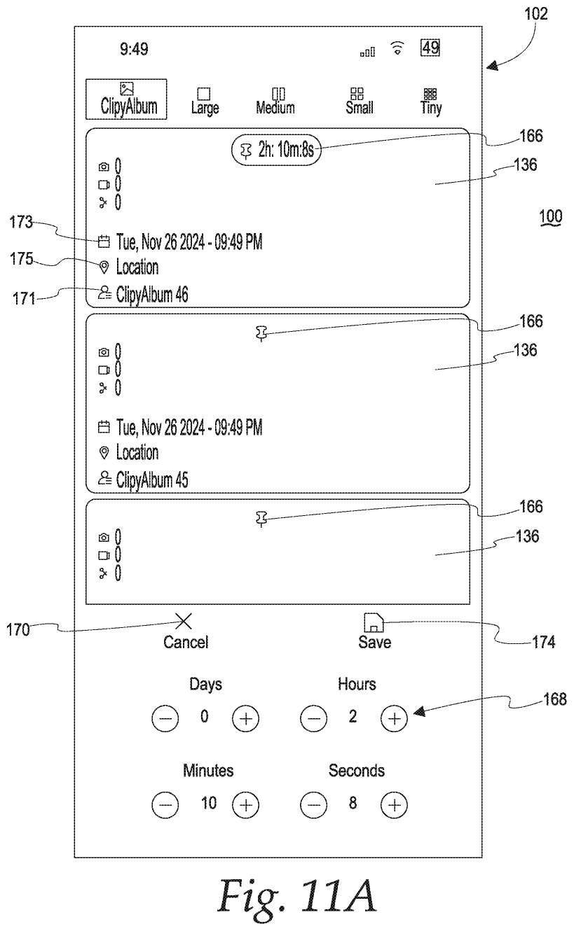

According to an aspect of the disclosure, a software application running on the recording system 100 includes an automated album management feature as now described, with reference to exemplary user interface views shown in FIGS. 2-11. Digital media files created using the application on the recording system 100, including video recordings, still images (photos or screen captures, for example), audio recordings, are stored in the storage 108 organized into logical entities referred to as “albums.” An album can contain one or more digital media files or be empty, that is, contain no digital media files. Thus, albums 136 are shown in an album listing interface view of FIG. 8 or FIG. 11 as separately labeled blocks containing a thumbnail image 138 of the most recent video frame or photograph stored in each non-empty album 136, as well as counters 140 of types of content contained in the album 136. The details of an individual album 136 are shown in an album detail interface view of FIG. 9, which can be accessed by a user tapping inside the block representing that album 136 in the album listing view of FIG. 8. The app uses a logical pointer called a “pin,” which at all times is “pinned” to (points to) only one of the albums 136, referred to herein as the “pinned” album 136. Whenever a digital media file is written to the storage 108, the file is stored in whatever album 136 is pinned at the time the file is written.

As shown in FIG. 8, each album 136 contains at least one “event” in which digital media files stored in the album 136 are organized into one or more subgroups. An “event” can include multiple media files, but in the illustrated embodiment, is limited to no more than one video file. In particular, the software application automatically generates a new event 142 within a currently pinned (explained below) album 136 each time a user completes a video recording, thus facilitating the separate grouping of each of a user's video recordings together with clips and snaps taken therefrom, as well as together with still photos taken during the same camera mode session, before beginning the video recording. This manner of automatically grouping clips, snaps, and photos into an event 142, which can be associated with no more than one video recording, is thought to be generally helpful for a user's file organization.

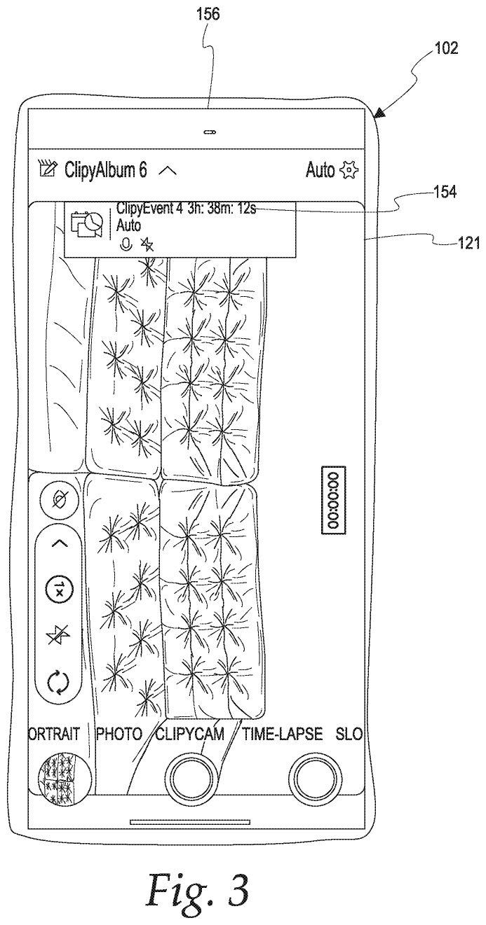

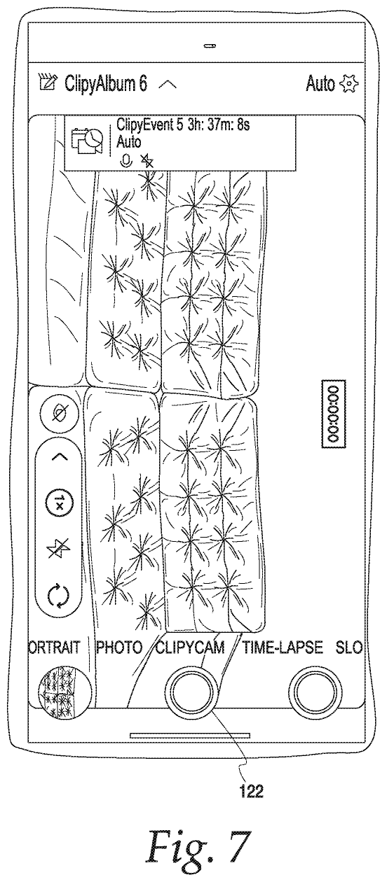

In the illustrated embodiment, whenever an album 136 is pinned, more particularly, one specific event 142 of that album 136 is pinned. Which is to say, when a digital media file is written to the storage 108, it will be stored in the pinned album 136 and grouped under the pinned event 142 of that album 136. Thus, as shown in FIG. 3, the app is ready to add recorded content to a pinned event 142 called “ClipyEvent 4.” A user then starts and stops a video recording using the record/stop control 122 in a sequence illustrated in FIGS. 5 and 6 (and also generates a clip from the video, as shown in FIG. 6 wherein a start/stop clip control 143 has been activated, where two seconds of clip recording time and fifteen seconds of “full video” recording time are indicated by the timers shown at the top of the viewfinder 121, shown in landscape orientation), which is then added to “ClipyEvent 4.” The app then logically defines and pins a new event 142 called “ClipyEvent 5,” as shown in FIG. 7. However, the queued new event (“ClipyEvent 5”) will only appear in the pinned album 136, in the album detail view of FIG. 9, if and when a user has recorded content to the pinned new event 142. Otherwise, the pinned new event 142 will be discarded when the album 136 to which it pertains is no longer pinned.

In embodiments, the album management aspect comprises an automatic file naming feature according to a convention now described. With reference to FIGS. 9 and 9A, each album 136 has an associated album name 137, each event 142 has an associated event name 141 that is unique within its parent album, while each clip file 146 and each photo file 148 has an associated item name 147 that is unique within its parent event 142. As mentioned previously, in the illustrated embodiment, each new main video file 144 is automatically assigned to a new event 142, such that each event 142 can only contain one new main video file 144. Thus, the event name 141 is unique to one video file 144 within the parent album 136 of the event 142. In that sense, the event name 141 also serves as the item name 147 of the associated video file 144.

In an automatic file naming convention according to an embodiment, when a file 144, 146, 148 is added to an album 136, the album name 137 (and optionally the event name 141 if different from the item name 147) is incorporated into a “stem” portion of a filename thereof. For purposes of this disclosure, the filename “stem” will be understood to refer to the portion preceding a file type identifier (“extension”) that is conventionally carried with the file 144, 146, 148, together with the extension, when the file is moved to another storage location and/or transmitted or copied to an external or remote device. Further, it will be understood that adding a file to an album 136 can refer to the initial creation of a file from recorded content when that album 136 is pinned or to moving the file into the album 136.

More particularly, the album name 137 can be prepended to the item name 147. (For example, in “MS-DOS” style syntax, as used in Windows® New Technology File System (NTFS), for purposes of this disclosure, the “stem” of a filename of a Microsoft® Word® document written as “C:\users\username\bookreport.docx” refers to “bookreport.”) For example, the file stem can be constructed by concatenating the three elements, with or without a delimiting character, as in “ClipyAlbum6_ClipyEvent4_Photo1” as the filename stem of the photo file 148 shown in FIG. 9. In other embodiments, the foregoing elements can be ordered differently in a filename stem, such as in the reverse order, Photo1_ClipyEvent4_ClipyAlbum6.” In other file organization structures, a media file may be contained directly within an “album” or analogous logical container, and a filename stem constructed by concatenating just two elements—a name of the “album” and an item name of the file, as in “ClipyAlbum6_Photo1” or “Photo1_ClipyAlbum6.”

The mechanics of automatic file naming according to this feature can be different in various embodiments. For example, in one embodiment, when a user snaps a photo or stops a video recording in progress, a file is automatically written with a filename stem according to the foregoing convention. In another embodiment, the entire filename stem according to the foregoing convention is auto-filled into a user-editable filename stem field, and the user can either accept the auto-filled filename stem (by pressing a Save button for example) or type a custom filename stem and then save the file under that custom filename stem. In still another embodiment, a user is only permitted to customize the item name portion of the filename stem, which will be automatically combined with the event name 141 and album name 137 according to the convention in effect.

In more particular embodiments of the automatic file naming feature, filename stems are automatically updated according to changing context relevant to the naming convention. For example, when a file is imported into an event 142 from outside the disclosed file organization system, the file is given a new filename stem formed by substituting a pre-existing filename stem into the above-described conventions in the position of the item name 147, combined with the event name 141 and album name 137 in the same manner. In another scenario, when a file is moved or copied within the disclosed system, from one event 142 to another event 142, the event name portion of the filename stem is updated to the event name 141 of the destination event 142 and, if the original and destination events 142 are in different albums 136, the album name portion of the filename stem is also updated to the album name 137 of the destination album 136. In addition, whenever the name 141, 137 of an event 142 or album 136 containing a file 144, 146, 148 is edited, the corresponding portion of the filename stem is automatically updated.

In still more particular embodiments in which the automatic naming mechanics allow a user to customize the entire filename stem, the filename stem is only updated automatically according to changing context if the user accepted the default filename stem according to the convention in effect. However, automatic contextual updating of the filename stem as described in the preceding paragraph is unaffected by user filename stem edits when the mechanics only permit the user to edit the item name portion.

“Events” can also facilitate the grouping of files by camera mode or camera use sessions, defined as time periods during which the camera mode is continuously active. Thus, in embodiments, an empty event 142 is pinned each time a user performs certain actions that open the camera interface, such as by initially launching or reopening the app, or by activating a control within the app that activates the camera mode from a different interface of the app, such as a camera mode link 145 displayed in the file navigation/gallery interface (as shown in FIGS. 8, 11). This ensures that any content captured during a new camera session will be grouped under a new event or events 142. If no content was captured during the immediately previous session, and the pin was not moved between the previous session and the current session, then the same empty event 142 that was pinned at the end of the last session will still be pinned at the start of the current session. This event 142 will remain pinned during a session, unless and until the user records a new video, when a new, initially empty event 142 is automatically created and pinned, as explained above. On the other hand, when a user snaps one or more photos, the pinned event 142 will no longer be empty when the user leaves the camera mode, such as by closing the app or opening an album listing view using the file navigation link 126. In that case, when the user reopens the app or returns to the camera mode by activating the camera mode link 145, a new, initially empty event 142 of the pinned album 136 is logically defined and pinned.

In the example of FIG. 9, an album 136 named “ClipyAlbum 6” includes files that are sub-grouped into four events 142, named “relaxation,” and “ClipyEvent 2” through “ClipyEvent 4,” thus illustrating one possible default sequential naming system for events 142, which a user can override by manually editing event information, such as by activating the edit event info control 133 shown in several of the drawings, including FIG. 2. As shown in FIG. 9, the event 142 named “ClipyEvent 4” is highlighted, and files 144-148 sub-grouped into that particular event 142 are represented in separate boxes below. These include a full video file 144 from which a clip file 146 was generated (such as by using a clip control as described in detail for the video recording systems disclosed in U.S. Pat. Nos. 11,380,359; 11,677,905; 11,818,461; 12,075,192; and 12,081,865, each of which is hereby incorporated herein by reference), and a photo file 148.

Each album 136 has an associated append or add content control 150, which is displayed both in the album listing view, as shown in FIG. 8 (and in another embodiment in FIG. 11), and in the album detail view, as shown in FIG. 9. When a user activates the add content control 150 of an album 136, a camera mode becomes activated, and the interface as in FIGS. 2-7 is again displayed, with that album 136 “pinned” (as explained below), its name being displayed in the pinned album indicator 134. Even an empty album 136 (not shown) has an associated add content control 150. An empty album 136 can be a daily album that was either manually created by a user or automatically created by the system 100 at the start of a new calendar day (automatic and manual creation of new albums are both described in more detail further below), to which the user has not yet added content.

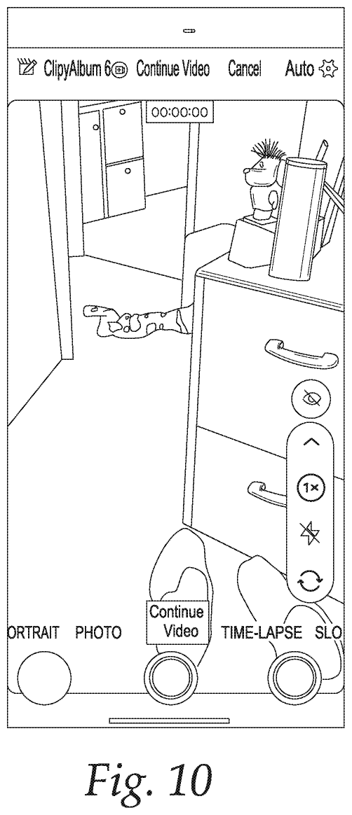

Similarly, each video file 144, 146 has an associated continue video or continue recording control 152, as shown in FIG. 9. User activation of the continue recording control 152 corresponding to a video file 144, 146 has several effects. First, a “continue recording” camera mode becomes activated, in which the record control 122 is operative to begin recording a new video segment to be appended to the corresponding video file 144, 146, resulting in the creation and storage of a new, merged video file when the user activates the record(/stop) control 122 a second time to stop recording the new segment. The original video file 144, 146 may either remain a separate logical and/or physical file or be deleted, based on either a prompted selection by the user or a preselected setting, which a user may select at any time by accessing settings using the settings control 128. Attributes and functionality of a continue recording (“continue video”) control suitable for the systems and methods disclosed herein are described in more detail in U.S. Pat. No. 12,081,865. The “continue recording” camera mode can remain active until the user cancels it by selecting “Cancel” in a continue recording interface view shown in FIG. 10, even overriding pin movement triggers described elsewhere in this disclosure, such as pin expiry by default at the end of a calendar day, or upon the expiration of a different, manually set pin time, and pin movement to a new empty event whenever a video recording is stopped or when a user navigates away from the camera interface or closes the app. In addition, the album 136 containing the original video file 144, 146 becomes “pinned” by the activation of the continue recording control 152, if it was not already currently pinned. Thus, according to an embodiment, after a user cancels continue recording mode, a new empty event 142 is created and pinned within the album 136 that contained the original video file 144, 146.

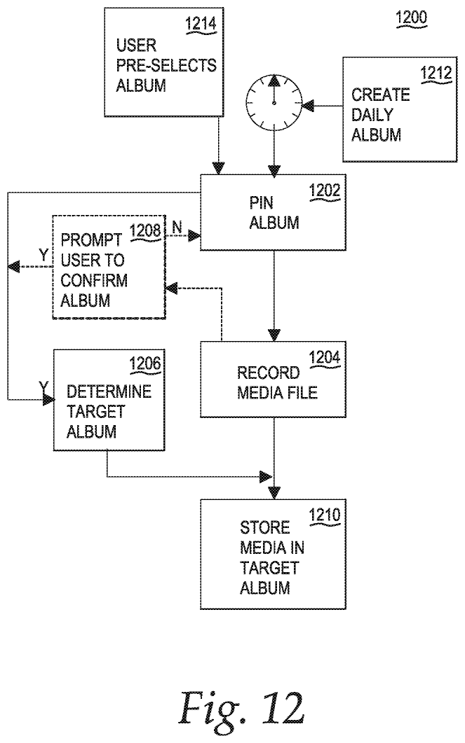

Whenever a user snaps a photo using the snap control 124 or records video and/or sound using the record control 120, the media file that is thereby generated is logically stored in one of the albums 136, following a programmed procedure of the software application of the system 100, as now described. The particular album 136 into which the file is organized is determined in accordance with a method 1200 according to an embodiment illustrated in the flowchart of FIG. 12. In a step 1202, a particular album 136 is “pinned,” as indicated to the user by the displayed pinned album indicator 134, as mentioned above and shown in each of FIGS. 2-7. In a step 1204, digital media is recorded by the recording system 100 and stored to available physical memory locations in the storage 108. In a step 1206, which may precede, follow, or occur concurrently with the physical recording and storage step 1204, it is determined to which album 136 a file containing the audiovisual content is or will be logically stored. In an embodiment, all files created using the application are automatically stored to the pinned album 136 without prompting, such that merely identifying the pinned album 136 constitutes the determining step 1206.

Other embodiments further include a step 1208 of prompting and receiving a prompted selection from a user of whether to save to the pinned album 136 or to a different album 136. In the case of a snapped photo, the user is prompted immediately after a user activates the snap control 124. In the case of a video or sound recording, the prompt can be presented immediately after the user activates the record control 122 to begin a new recording, or only after the user activates the stop control 122 to end a recording in progress. In either case, in response to the prompt, the user can choose to confirm the currently pinned album 136 as the save location, to create a new album 136 as the save location, or to save the new file to another existing album 136. In embodiments, when the user elects to save to a new or existing album 136 that is not currently pinned, the prompting and user selection step 1208 feeds back into the pinning step 1202 for the user-specified album 136 to be pinned. In other embodiments, the new file is saved to the user-specified album 136, while the pinned album 136 remains the same for purposes of executing the method 1200 to determine the destination album 136 of the next file to be recorded. In a final step 1210, following the completion of the file recording and target album determining steps 1204, 1206, the newly recorded media file (such as the video and photo files 144-148 represented in FIG. 9) is stored in the album 136 determined to be the target album.

Another way that a user can add content to an album 136 is by importing it. In particular, a user can open the gallery interface by selecting the file navigation link 126, select an album listing view (“ClipyAlbum”) from the view selection ribbon 160 of FIG. 8, select a particular album 136 from the album listing view to open the album detail view of FIG. 9, and activate an event content edit control 162. A user is then presented an “Arrange Event” view (serving as an event content import view for importing content to an event) as shown in FIG. 9A, from which the user can select an event 142 from the selected album, for which an import content button 164 will appear for each content type, shown as “FULL VIDEO,” “CLIPS,” and “PHOTOS.” The app will then display a source selection (“Add from”) menu 165 prompting a user to import content of the selected type (clips 146 in the example shown in FIG. 9A) to the selected event 142, either from within the file system of the app (by selecting “ClipyCam”) or from another file system, such as a device file system of the camera device 102 or any other file system in the (local or remote/cloud) storage 108 (by selecting “Photos”). When a user activates the import content button 164 for a full video 144, a user can be prompted to “Replace from,” rather than to “Add from” one of those sources, as in the illustrated embodiment, only one full video 144 can be associated with a given event 142.

In the illustrated embodiment, the method 1200 further includes a daily album creation step 1212, in which a new daily album 136 is created automatically at the start of every calendar day. More particularly, the software application is configured to create a new daily album 136 for each user of the application and/or on each recording system 100 on which the application is running. For example, where new daily albums 136 are assigned per user, the application can be configured for a user to log in to a user account, which will connect the user's electronic device 102 to a system server, and the storage 108 can be a remote (cloud) storage device to which the server grants the user access via any electronic device 102 that the user is logged into. In addition, the method 1200 further includes a step 1214 in which a use manually selects an album 136 to be pinned, such as by activating the add content control 150 corresponding to that album 136 from interface view from FIG. 8, FIG. 9 or FIG. 11, by activating the continue recording control 152 of a video file 144 or 146 contained in that album 136 from the album detail view of FIG. 9, as previously described, or by activating a pin-control 166 associated with the album, with reference to FIGS. 11-11A and described further below. The daily album creation step 1212 and the user pre-selection step 1214 independently feed into the pin album step 1202. Thus, in general, the pinned album 136 will be reassigned in the step 1202 following step 1212 or step 1214, each time either of them occurs.

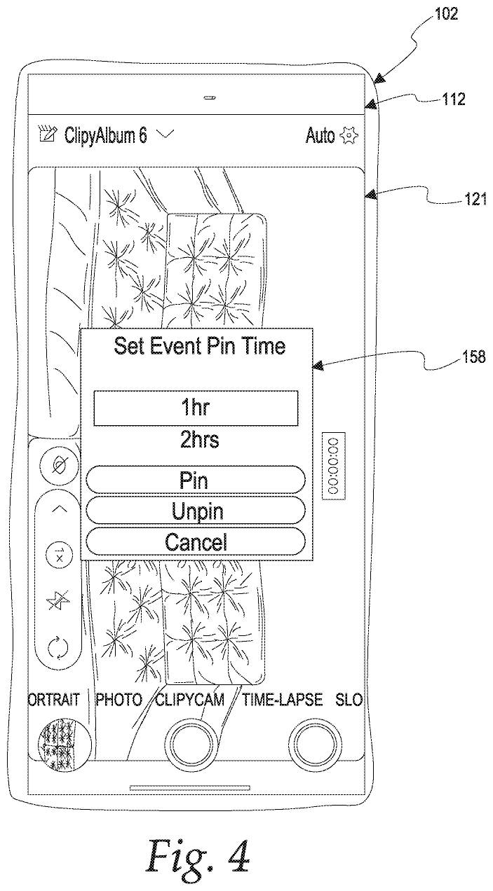

However, in the illustrated embodiment, the timing of the daily album creation step 1212 can be overridden by a user setting a pin timer, with reference to FIGS. 3-4 and FIGS. 11-11A. Turning to FIG. 3, there is shown a pin timer 154 that is displayed when a user activates a dropdown control 156 associated with the pinned album indicator 134. By default, at the time that an album 136 is pinned, the associated pin timer 154 is set to expire at the end of that calendar day. However, a user can set the pin timer 154 manually by tapping the pin timer 154 or an associated control icon or area, to bring up a set pin time panel 158 as shown in FIG. 4, and interacting with the panel 158 to select and confirm a pin time.

Alternatively or additionally, a pin time can be set by a user activating the file navigation link 126 and opening an album detail interface view according to another embodiment as shown in FIG. 11, wherein each existing album 136 is displayed with an associated pin control 166, which a user can activate to open a set pin time panel 168, as shown in FIG. 11A, according to another embodiment, allowing the user to specify a pin time in days, minutes, hours, and seconds.

In an “exception to the exception” according to embodiments, the app can be programmed so that a pin time currently set to expire for a pinned album 136 before the end of a day is automatically extended whenever a user activates the continue recording control 152 of a video file 144 or 146 contained in an event 142 of the album 136. For example, the pin time for the album 136 that contains the corresponding video file 144 or 146 can be extended to the end-of-day default, or until the user has canceled the current “continue recording” activation by selecting “cancel” in the “continue recording” interface view shown in FIG. 10. In some embodiments, “continue recording” mode will remain active until manually canceled by the user, regardless of manual or default album pin expiration times, as well as regardless of other actions or inputs that would otherwise result in the pinning of a new empty event as described above. This exception to the exception can prevent the continue recording mode from being deactivated before a user is finished appending new video segments to the video file 144 when activating the record control 122, requiring the user to navigate back to the video file 144 and reactivate its continue recording control 152 in order to resume appending new segments.

Also illustrated in FIG. 11 are controls for creating a new album 136, pinning an album 136, and editing the metadata or properties of an album 136. When a user activates an add album control 170, a new album 136 is created with default editable properties including an album name property 171, a date-time property 173, and a location property 175 (in embodiments, an album can have more, fewer, and/or different editable properties). More particularly, the new album 136 can appear as shown at the top of FIG. 11A, for which the name property 171 is a default sequential value in a default format, illustrated as “ClipyAlbum 46,” the date-time property 173 is set to the current time read from a clock utility of the camera device 102, and the location property 175 can either be unspecified or a current location detected by a GPS system of the camera device 102. The new album 136 is pinned by default upon its creation until the end of the current day as indicated adjacent its corresponding pin control 166. A user can then modify the pin time, if and as desired, in the panel 168. When a user thus manually sets a pin time that will expire before the end of the current calendar day, a new empty album 136 is automatically created and pinned upon the expiration of the manually set pin time, as in the step 1212 of creating a new daily album. On the other hand, when a user manually sets a pin time that will not expire until after the end of the current calendar day, the daily album creation step 1212 is deferred until the expiration of the manually set pin time. A user can cancel manually setting the pin time by activating a cancel control 172 or save the pin time selected in the set pin time panel 168 by activating a save control 174. Activation of either the cancel control 172 or the save control 174 returns the interface to the album listing view as shown in FIG. 11, wherein a user can then edit the metadata or properties 171-175 of the newly created album 136 or any other album 136, by activating a corresponding album edit control 177.

According to another album management aspect of the present disclosure, the application software is programmed so that certain conditions trigger the automatic deletion of empty albums 136.

First, whenever a user empties an album 136 by removing every file 144-148 contained in that album 136, the album 136 will be deleted automatically. In embodiments, such automatic album deletion only occurs subject to one or more additional conditions. For example, one such additional condition is that an empty album will only be deleted automatically if the user has also made no changes to any of an album's default metadata or properties, such as an album name, associated location(s), or associated date(s). A user can also be notified by a displayed message (not shown) whenever an empty album 136 is deleted.

Second, any empty album(s) 136, are automatically deleted at the end of each calendar day (again, in embodiments, excepting any empty album(s) 136 with user-modified metadata or properties). This includes the daily album 136 that was automatically created at the start of the day, in addition to any album(s) 136 created manually by the user during the day, to which the user has not added content by the end of the day.

A user has at least three ways of creating a new album 136, or causing one to be created, during a given calendar day (i.e., at times other than 12:00 am on that or the following day).

A first way is for the user to activate the add album control 151 displayed in the album listing view of FIG. 8.

A second way is for the user to “unpin” a currently pinned, non-empty album, by activating a dropdown control 156 from a camera mode view as shown in FIG. 2 to bring up a pin timer 154 as shown in FIG. 3, selecting the pin timer 154 to bring up a set pin time panel 158 as shown in FIG. 4, and selecting “unpin” from the set pin time panel 158. In response to the user selecting “unpin,” the app automatically generates and pins a new empty album 136 in place of the previously pinned album 136, while removing the latter as the pinned album. The previously pinned album 136 is not deleted; the logical entity and its contents remain accessible by activating the file system navigation control 126 and selecting an album view (denoted “ClipyAlbum,” and highlighted as the selected view, in a view selection ribbon 160 shown in FIG. 8), but is no longer the current album 136 to which new media files are saved as they are created.

A third way is for the user to open the pin time panel 158 and set a pin time that will expire at any other clock time than midnight, resulting in a scheduled unpinning of a currently pinned album 136 upon the expiration of the pin time, in response to which the app automatically generates a new empty album 136 just as it does in the case just described of the user manually unpinning the album 136 in real time. However, in either case, if a currently pinned album 136 was never used to store content (or otherwise modified by a user, such as by applying a descriptive name in anticipation of capturing particular subject matter during the pin time), then currently pinned album 136 remains pinned, no new album 136 is created, and the app takes no action when the pin time expires or a user attempts to unpin the album. The app can be programmed to ignore such a manual request with or without notifying the user, as the result of taking no action, an empty album 136 having default properties (name and other, if any) remaining pinned, is essentially the result the user expects to attain by unpinning the album 136.

### Visual Overlays

### General Description of Overlays According to the Disclosure

According to another aspect of the disclosure, systems and methods are provided for organizing, combining, and applying visual overlays to visual media files, as well as live manipulation of the same overlays during streaming and/or recording. In particular, the software application provides a user a set of tools and features for associating one or more overlays of various types to an album, so that when the album is pinned, the overlay(s) will appear by default over captured digital media frames of files stored in the album. An overlay can, for example, be a visual brand (such as a name and/or logo of a business that is delivering visual media files to a customer in connection with services such as real estate sales or rental, property inspection or management, construction or repair services, event photography/videography or the like) information about the content of the image (for example, a description or name of the subject matter being captured, such as a name of an event, geographic landmark, or human-made structure), or other information about the captured media, such as geolocation coordinates or physical address, weather information, date/time, etc.

While capturing visual media using an overlay, a user will see in a digital viewfinder of a camera device, or in the case of screen recording, in the display of the screen area being recorded, a composite frame image or images produced by combining the overlay with the captured visual content (live scene or active display image). The overlay can, for example, appear as a watermark or opaque image superimposed over the captured visual content, or otherwise be combined with each image frame of captured visual content so as to modify it in a characteristic way, such as by a distinctive filter or the like, to form a composite image frame of the visual media file to be stored in the album. During recording or streaming of the composite image frames, a user can manipulate overlay image content appearing in the composite image frame area as desired, such as by moving, resizing, or temporarily toggling off the overlay image content so that it does not cover or alter part of the captured image content. For example, the user can touch and drag a superimposed brand image on a touchscreen display to reposition it, or quick-tap or double-tap the brand image to toggle it off, and repeat the same quick-tap or double-tap input to toggle it back on, while resizing can be executed in a suitable manner, such as by commonly employed two-finger diverging and converging touch inputs.

The software application also provides an overlay control that allows a user to apply (or remove) overlays independently of a pinned album. User input using the overlay control can override an album overlay, for example only during capture of a next photo, video, screenshot, or screen recording, followed by the system reverting to the album overlay of the pinned album for a next subsequently captured video or still image file.

Overlays can be either static or dynamic. Frequently used static overlays (such as brand text or a brand logo) can be stored in a system storage to be available for a user to select as album overlays or single-file overlays using corresponding user interface overlay tools or menus of the software application. Examples of dynamic overlays that can be applied include a digital timestamp (which may indicate, for example, a time remaining in a countdown or an elapsed recording time), geolocation text, or digital sensor measurements, such as of light levels, temperature, or other ambient conditions. Rather than being stored in a system storage component, the image data of a dynamic overlay is thus be read by a processor from a another operatively connected system component such as a clock, geolocation component, or physical sensor. A dynamic overlay is updated according to instructions from the system software application, such as periodically during the time for which the dynamic overlay is active, or only once at the time the dynamic overlay is initially activated by a user. The dynamic image content of a dynamic overlay is not typically stored in the storage, as its content is determined at the time it is applied to produce composite image frames being recorded or streamed to a displayed user-interface. However, instructions for dynamically determining and generating the image content can nonetheless be stored, and a dynamic overlay can accordingly be assigned to an album as a dynamic album overlay by associating such stored instructions to the album.

### Illustrated Embodiment of Overlays in a Mobile App User Interface

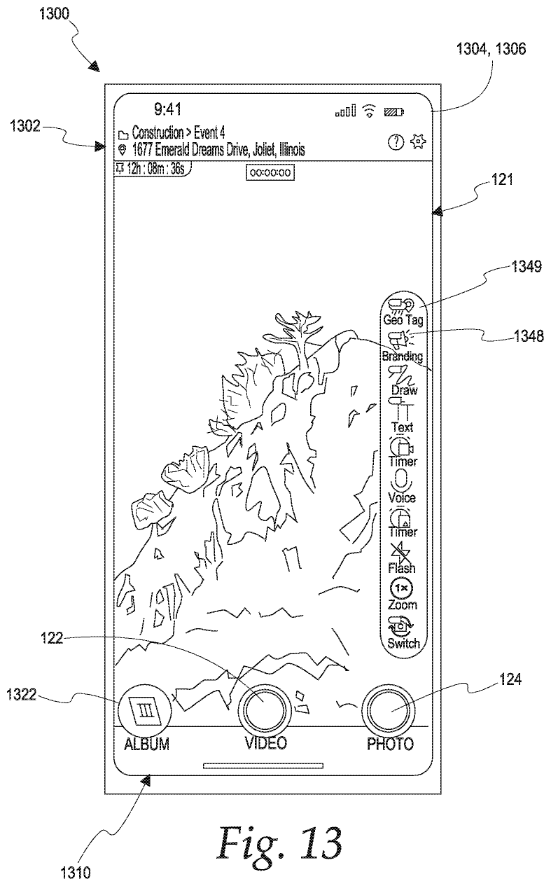

According to the present aspect of the disclosure, an embodiment of a digital visual media recording and file organization system 1300 incorporating overlay tools and features is illustrated in FIGS. 13-20. The illustrated system 1300 includes a camera device 1302 (depicted as a smartphone) executing a software application to display a graphical user interface 1304 on a touchscreen display 1306. The camera device 1302 includes a processor operatively connected to the camera and to a storage and the touchscreen display 1306, substantially as described for previous aspects and embodiments.

However, it will be appreciated that the overlay tools and features according to the presently described aspect can also be incorporated into another system or another mode in which source image content is captured by a screen recorder instead of a camera, in which the user interface would include the same controls, and the image frames captured by the screen recorder from a device display could be displayed in a digital viewfinder in the same manner as the image frames captured by the camera device from a live scene in the illustrated embodiment, while the user may continue interacting, for example, with an operating system desktop or other applications on the user's device display so as to produce the content of the image frames captured. Optionally, to distinguish or avoid obstruction between the graphical controls of the presently disclosed software application and those of other applications during screen recording, the disclosed software application can display a single graphical toggle control, not shown in the drawings, to toggle on or off all other graphical interface content associated with the application, including menus, features, and other controls. In other ways, with the graphical interface content toggled on by such a control, the appearance of the user interface could be essentially as illustrated in FIGS. 13-20 for a camera-based recording system.

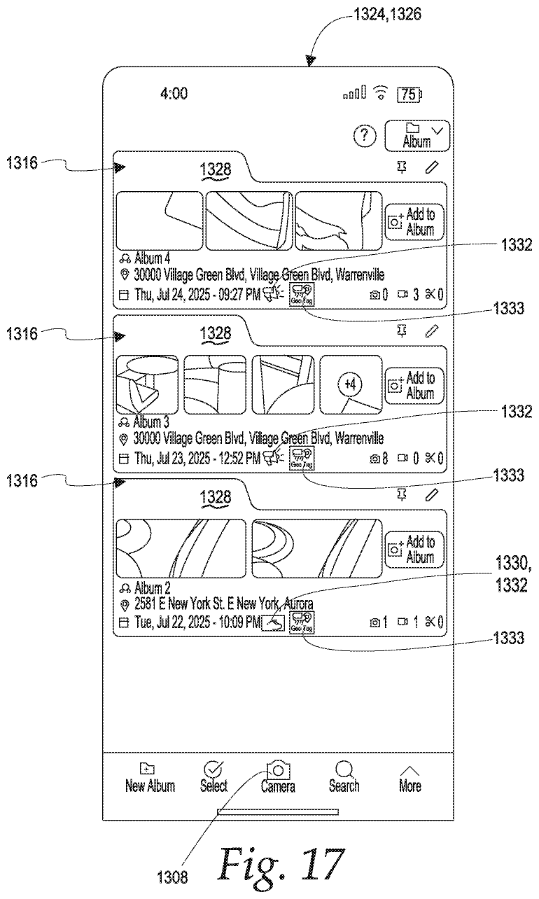

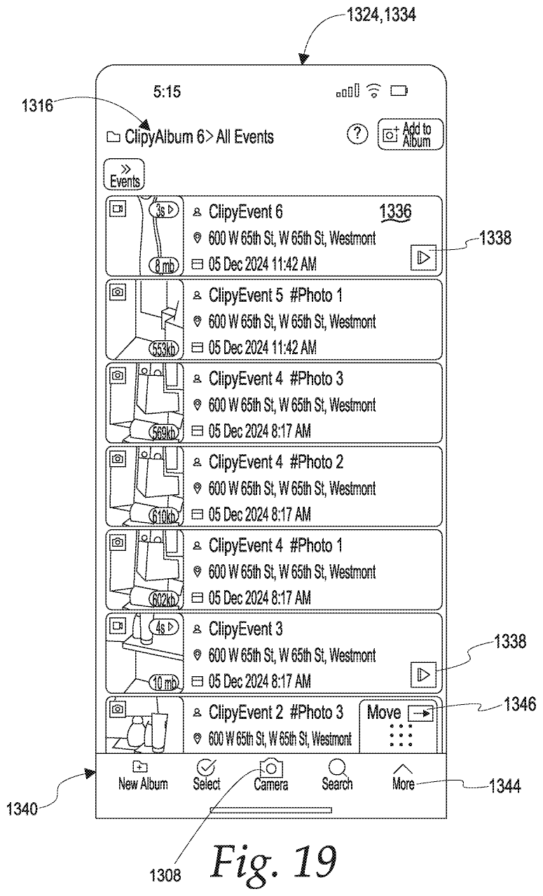

The software application includes instructions for the processor to display touch controls on the display 1306. The touch controls include a camera control 1308 (shown in FIGS. 17 and 19) and at least one capture control (illustrated as a record control 122 and a snap control 124). When the camera control 1308 is activated, a camera interface 1310 is displayed on the display 1306, the camera interface 1310 comprising a viewfinder area 121, the record control 122, and the snap control 124.

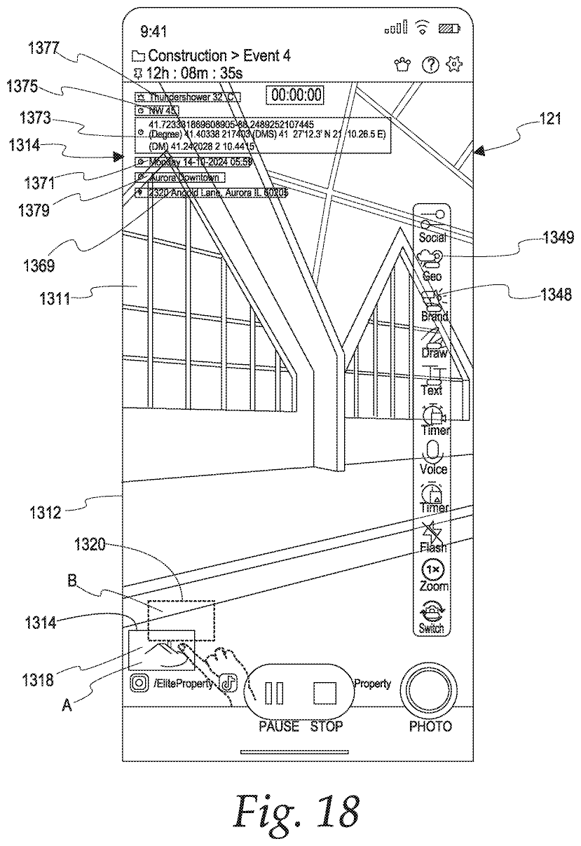

The user interface 1304 provides one or more overlay touch controls or menus for the user to enter touch inputs to determine (select or define) an overlay comprising overlay image data to be applied to image frames captured by the camera. In response to such user inputs, the processor can activate or deactivate an overlay. While an overlay is active and the camera interface is displayed, the processor applies the active overlay to a captured image frame 1311 of the live scene that is captured by the camera and displays a resulting composite image frame 1312 in the viewfinder area 121, as seen, for example, in FIG. 18. In particular, the overlay image data of the active overlay is combined with the captured image data of the live scene to produce composite image data, the composite image data representing the composite image frame 1312. The captured image frame and the composite image frame 1312 are referred to herein as having a “frame area” in common, and the overlay is said to modify the captured image frame within an overlay area 1314 inside the frame area, where the frame area corresponds to the viewfinder area 121 as seen in FIGS. 13, 14, 16, 18, 20 for example. When the record control 122 or snap control 124 is activated while an overlay is active, the processor is instructed to write to the storage a visual media file (video or photo) comprising at least one of the composite image frames 1312.

More particularly, the system 1300 comprises a plurality of albums 1316. Each album 1316 is stored in the storage. The album 1316 comprises a logical album entity including zero or more file references corresponding to zero or more visual media files stored in the storage. Each file reference identifies a physical location in the storage of the referenced file and a designation of the referenced file as being stored in the album. An album 1316 can be assigned an overlay by adding an album overlay reference to its logical album entity. The album overlay reference can designate one or more stored static overlays or dynamic overlays, as album overlays assigned to the respective album, as illustrated in FIG. 18. The albums 1316 can be pinned, as described in detail for a previously presented aspect of this disclosure, in response to an album-pinning user input. When a visual media file is written to the storage while an album is pinned, the visual media file is stored in the pinned album, substantially as previously described.

When an album having an album overlay is pinned, the processor activates the album overlay, thus combining the overlay image data with the captured image data to produce the corresponding composite image frames 1312 displayed in the viewfinder area 121, and to include the composite image frames 1312 in any visual media file that is stored while the album overlay is active. As illustrated in FIG. 18, a user can move the position of an overlay image 1318 relative to the live scene in the composite image 1312 by applying a touch input on the overlay image 1318, such as a touch-and-drag movement with one fingertip. Subsequently displayed composite image frames 1312 are thus modified by the relocated position of the overlay image 1318. According to an embodiment, the composite image frames 1312 displayed in the digital viewfinder area 121, and those of a video file being recorded during such movement of the overlay image 1318, will reflect movement of the overlay image 1318 through a range of intermediate positions along a path from a starting position A to an end position B during the user's touch-and-drag movement. In another embodiment, the composite image frames 1312 displayed and captured during the user's touch-and-drag movement will be unaltered until the movement is completed, when the next and any subsequent composite image frames 1312 will show the overlay image 1318 at its end position B. In the latter embodiment, a moving ghost outline 1320 of the overlay image 1318 can be displayed to the user in the viewfinder area 121 during the touch-and-drag input to indicate to the user where the end position B of the overlay image 1318 will be when the user completes the touch-and-drag input by lifting the user's fingertip from the touchscreen display 1306. The image of the ghost outline 1320 itself need not be included in the composite image frames 1312 of a video file being recorded during the touch-and-drag input.

As in the previously described album management aspect of the disclosure, a file navigation control 1322 (shown in FIG. 13) is operative, when activated, to display a file navigation interface 1324 on the display 1306, as shown in FIGS. 17 and 19. Referring to FIG. 17, the file navigation interface 1324 includes an album listing view 1326, the album listing view 1326 comprising a plurality of album areas 1328 respectively representing the plurality of albums 1316. Each album area 1328 comprises visual album indicia 1316 uniquely identifying the respective album 1316.

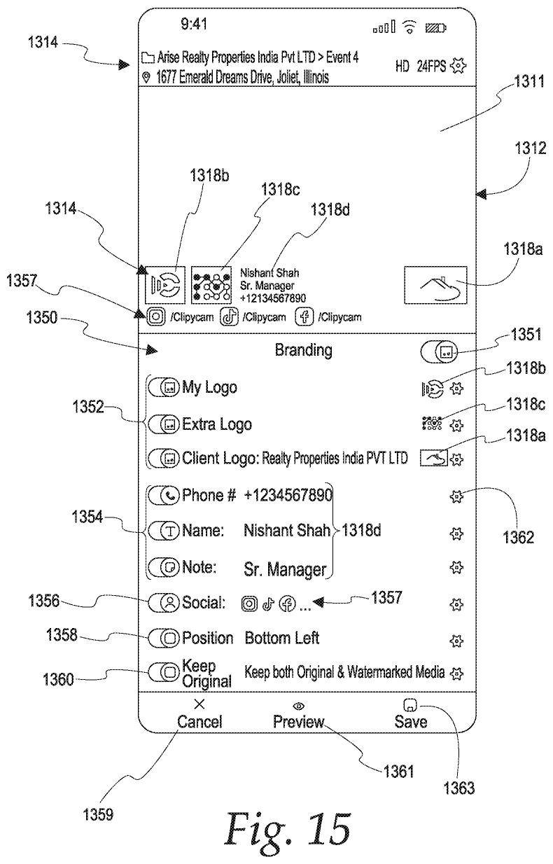

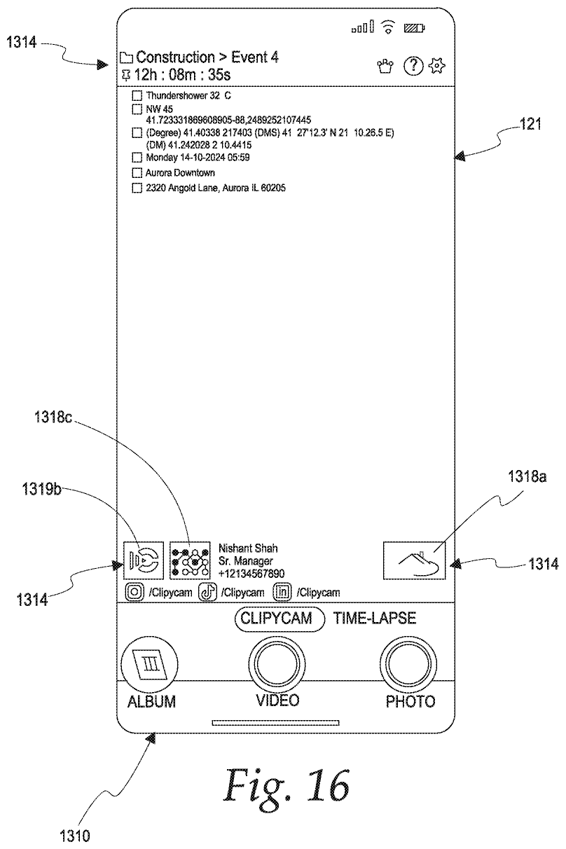

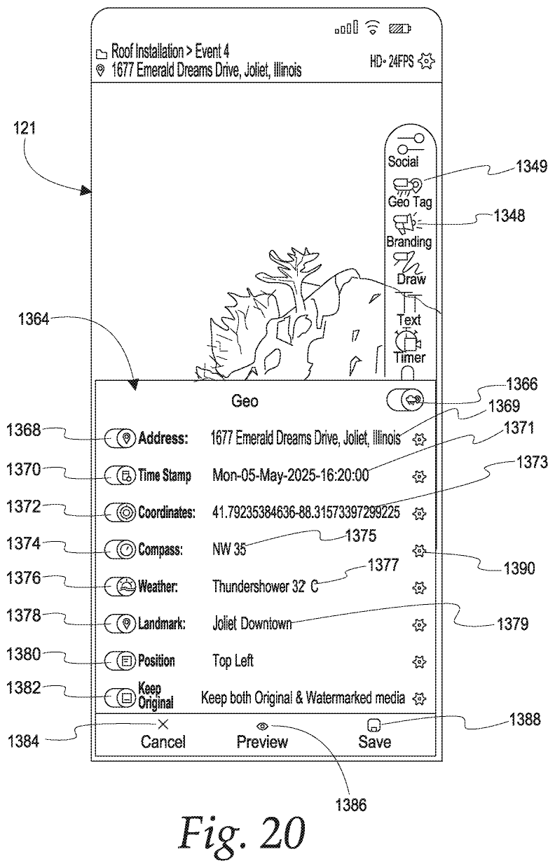

Each album area 1328 further comprises one or more album overlay controls 1332, 1333. The album overlay controls 1332, 1333 are operative, when activated, to accept a user input to assign one or more overlays as an album overlay of the respective album, or to remove or modify an album overlay already assigned. More particularly, the album overlay control 1332 corresponds to static overlays, and still more particularly branding overlays, having the associated branding overlay images 1318a-1318d as shown in FIGS. 15 and 16 and described further below, the album branding overlay control 1332 being operative to display the branding overlay options menu 1350, as shown in FIG. 15 but with the album listing view 1326 remaining in the background (not shown). In turn, the album overlay control 1333 corresponds to dynamic overlays, and still more particularly Geo Tag overlays having the associate overlay images 1369-1379 as shown in FIGS. 18 and 20 and described further below, the album Geo Tag overlay control 1333 being operative to display the Geo (Tag) branding overlay options menu 1364, as shown in FIG. 20 but with the album listing view 1326 remaining in the background (not shown).

In embodiments, active album overlay indicia can optionally be displayed in the album area 1328 of an album 1316 having an album overlay already assigned and activated. The album overlay indicia can comprise an image that uniquely identifies the specific overlay that is assigned and activated to the respective album 1316, such as a thumbnail of the corresponding overlay image, as in an album overlay indicia 1330 shown in FIG. 17. In the illustrated example, the album overlay indicia 1330 is a thumbnail of a specific branding overlay, which also serves as the album branding overlay control 1332 of the corresponding album 1316.

Referring to FIG. 19, the file navigation interface 1324 further includes an album detail view 1334 for each of the albums 1316, as shown for one of the albums 1316. The album detail view 1334 can be displayed by a user touch input in the corresponding album area 1328. The album detail view 1334 includes a video file area 1336 for each video file previously stored in the respective album. The video file area 1336 includes a continue recording control 1338. As previously described above in connection the album management aspect, the continue recording control 1338 is operative, when activated, to initiate recording of a continuing video segment from the camera to be appended to previously recorded video of the previously stored video file. In an embodiment, prior to the initiation of said recording of the continuing video segment (or alternatively, during said recording), a user can be prompted to specify or select a continuing overlay for the continuing video segment. When the user selects a continuing overlay, the processor activates the selected continuing overlay for the continuing video segment, so that the continuing video segment comprises composite image frames having the continuing overlay applied to corresponding live scenes captured by the camera. When the user stops the continued recording, a combined video file is generated and stored in the storage, comprising the previously recorded video and the continuing video segment (the continuing video segment including the continuing overlay) appended to the previously recorded video.

When the continuing overlay is an album overlay uniquely assigned to a “destination” album other than the “source” album in which the previously stored video file was stored, the processor can be instructed to store the combined video file in the destination album only, in both the source and destination albums, or in the source album only, automatically or in accordance with a prompted user selection. The previously stored video file can be discarded, or it can likewise be stored in either or both the source and destination albums, automatically or by user selection. When either video file is stored in multiple albums, this need not entail writing a duplicate copy of the combined video file to the physical storage, as the file references to the video file of both albums can simply identify the same physical location in the storage of a single copy of the video file.

The album detail view 1334 further comprises a menu panel 1340, as shown in FIG. 19, which includes the camera control 1308, an album listing view control 1342 that is operative to reopen the album listing view 1326, and a More control 1344. The More control 1344 is operative to expand the menu panel 1340 to expose more controls including a move file control 1346. The move file control 1346 can be operative, when activated, to receive a user input selection to move a video file from the current album 1316 to a destination album. When the file is moved to the destination album, the continue recording control 1338 for the video file in the destination album is operative, when the destination album has an assigned album overlay, to initiate recording of a continuing video segment comprising composite image frames in which the destination album overlay is applied only to the continuing video segment, without altering the previously stored video.

Returning to FIG. 13, the camera interface 1310 further comprises one or more camera overlay controls 1348, 1349, the camera overlay control 1348 being labeled as a “Branding” camera overlay control, and the camera overlay control 1349 being labeled as a “Geo Tag” camera overlay control, reflecting common uses of overlays to apply associated branding or geotag information (e.g., global position, time, compass direction of camera, weather, landmarks, etc.) to an image. The camera overlay controls 1348 and 1349 are operative, when activated, to prompt a user input selection of one of the overlays to be activated, and to activate the selected overlay. As previously mentioned, when the user's selection results in a change to the album overlay(s) assigned to a pinned album, the pinned album overlay(s) can be overridden, for example only for the next visual media file captured and stored to the storage, upon which the processor deactivates the overlay that was selected using the camera overlay control 1348. In other embodiments, the pinned album overlay(s) can be overridden until a user input manually reverts to the pinned album overlay(s), or subject to some other subsequent condition. In still another embodiment, instead of overriding the pinned album overlay(s), the user can be prompted to modify the same by assigning the currently selected overlay as another album overlay of the pinned album.

Shown in FIG. 15 is an illustrative example of a branding overlay options menu 1350 that is displayed in response to a user activation of the Branding camera overlay control 1348. In embodiments, the branding overlay options menu 1350 is also displayed in response to a user activation of the album overlay control 1332 shown in FIG. 17, while in other embodiments the album overlay control 1332 is operative to present a user with a general listing over overlay options, or to prompt a user selection from different overlay types, such as branding, geotagging, and/or other types, and to display an options menu for the selected type of overlay. The branding overlay options menu 1350 includes a global toggle control 1351 which must be toggled on (to the right as displayed) for any Branding overlay to be activated. The branding overlay options menu 1350 further includes logo display controls 1352 for toggling on and off a client logo 1318a, a user logo 1318b, and a user extra logo 1318c; text display controls 1354 for toggling on and off text display items 1318d (illustrated as a person's name, title, and phone number, such as the user's); a social media platform control 1356 for toggling on and off associated social media platform logos 1357; a Position control 1358 for designating a position of an overlay area 1314 for the branding overlay images 1318a-d and/or 1357; and a Keep Original control 1360 for toggling on and off the option of writing and storing separate files of the (“original”) captured image frame(s) 1311 and composite image frame(s) 1312 of the recorded visual media (photo or video). Each control 1352-1360 has an associated settings control 1362 which a user can activate to select or edit the action associated with the respective control, such as selecting the images or text to be displayed when the controls 1352-1356 are toggled on. A Cancel control 1359 is operative to cancel any changes to selections in the Branding overlay options menu 1350 that were most recently saved and thereby revert to the previously saved selections, a Preview control 1361 is operative to display a preview of the full digital viewfinder 121 with the current selections activated, and a save control 1363 is operative to activate and save the current selections.

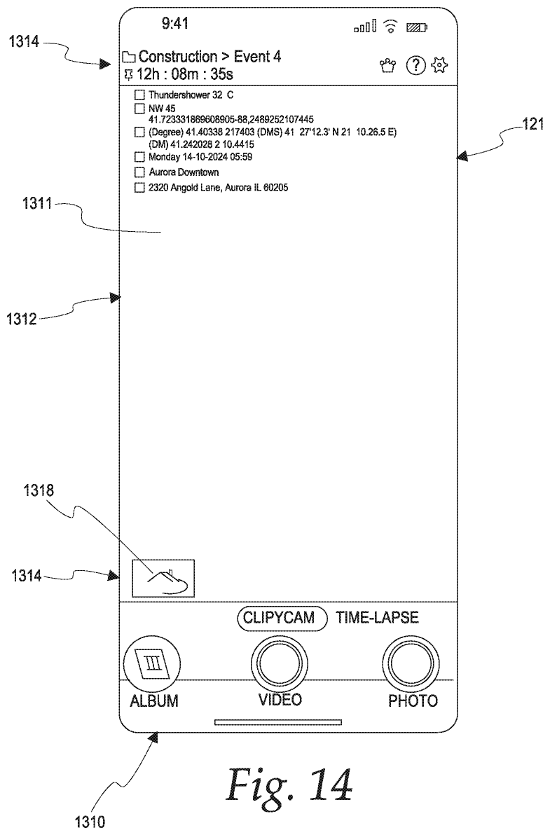

When an overlay is already active at the time of any user input selection that activates another overlay, the processor is instructed to determine whether the overlay area of the newly selected overlay overlaps the overlay area of the already active overlay. When such overlap occurs, the processor automatically modifies one or both overlays to reposition the respective overlay area(s) so that the respective overlay areas do not overlap. For example, as illustrated in FIG. 15, wherein a user has activated multiple branding overlay images by toggling on each of the controls 1352-1356 while Bottom Left remains specified by the position control 1358, the overlay image 1318 (corresponding to the client logo 1318a) that had previously appeared in the lower left corner of the image frame as shown in FIG. 14 is “bumped” over to the lower right corner of the image frame to make room for the user logos 1318b and c, as shown in a preview in FIG. 15 and in the camera interface view 1310 of FIG. 16. In other embodiments not shown, the position of each specific overlay image 1318a-d, 1357 is specified separately in the settings 1362 of the corresponding control 1352, 1354, 1356, and an overlay image is only “bumped” to another position if its position conflicts with that of another active overlay image.

Turning to FIG. 20, a Geo Tag overlay options menu 1364 is illustrated, which is displayed in response to an activation of the Geo Tag camera overlay control 1349. The Geo Tag overlay options menu 1364 includes a global toggle control 1366, which must be toggled on (to the right as displayed) for any Geo Tag overlay to be activated. In addition, the menu 1364 includes an Address control 1368, a Time Stamp control 1370, a Coordinates control 1372, a Compass control 1374, a Weather control 1376, a Landmark control 1378, a Position control 1380, and a Keep Original control 1382. The controls 1368-1378 (even numerals) are operative, respectively, to activate and deactivate a corresponding Address overlay 1369, Time Stamp overlay 1371, Coordinates overlay 1373 (geographic position), Compass overlay 1375, Weather overlay 1377, and Landmark overlay 1379. The base position of the respective activated geotagging overlays 1369-1379 (odd numerals) is designated using the Position control 1380, with successive active overlays being “bumped” to lower positions in the designated top left corner of the digital viewfinder area 121, as illustrated in FIG. 14. The order of “bumping” can be based on a predetermined hierarchy, an order in which the overlays 1369-1379 were activated, and/or an order manually specified by a user (not shown) in a settings control 1390 corresponding to the Position control 1380. Alternatively, as analogously described above for the Branding overlays menu 1350, a corresponding settings control 1390 can be used to separately specify the position of each individual geotagging overlay 1369-1379. The settings control 1390 can also be operative to enable a user to otherwise set properties of the corresponding overlay 1369-1379, such as by entering or editing a “value” or the formatting of a text string to be displayed as the content of a corresponding overlay image. A Cancel control 1384 is operative to cancel any changes to selections in the Geo Tag overlay menu 1364 that were most recently saved, a Preview control 1386 is operative to display a preview of the full digital viewfinder 121 with the current selections activated, and a Save control 1387 is operative to activate and save the current selections.

### General Notes on the Disclosure

Although the process-flow diagrams of this disclosure show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

Throughout this disclosure, streams and clips are generally described as audiovisual streams and clips. However, it should be understood that the principles described herein can be applied to streams and clips of purely audio or purely video.

In the preceding description of various examples of embodiments of the disclosed systems and methods, reference is made to the accompanying drawings, which form a part hereof, and in which are shown by way of illustration various example devices, systems, and environments in which aspects of the disclosed system and method can be practiced. Other specific arrangements of parts, example devices, systems, and environments, can be used, and structural modifications and functional modifications can be made without departing from the scope of the disclosed system and method.

The preceding description of the disclosure has been presented for purposes of illustration and description and is not intended to be exhaustive or to limit the disclosure to the precise form disclosed. The description was selected to best explain the principles of the present teachings and the practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification but be defined by the claim(s) set forth below. In addition, although narrow claims may be presented below, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or more applications to claim such additional disclosures is reserved.

What is claimed is:

1. A digital media file recording and organization system comprising:
a recording component, the recording component being operative to record audiovisual content comprising at least one of images and sound, to generate digital media data from the recorded audiovisual content, the digital media data comprising at least one of digital image data representing recorded images and digital audio data representing recorded sound;
a processor, the processor being operatively connected to the recording component to read the digital media data from the recording component;
a storage, the storage comprising a non-volatile computer-readable medium including physical memory locations, the physical memory locations being adapted and configured to store a plurality of digital media files, each digital media file being stored in a set of one or more of the physical memory locations, each digital media file comprising at least a portion of the digital media data read from the recording component, the processor being operatively connected to the storage to write the digital media files to the physical memory locations and to read the digital media files from the physical memory locations;
a software application, the software application comprising computer readable instructions stored in the storage, the processor being operative to read and execute the instructions from the storage;
a display, the processor being operatively connected to the display, the software application including instructions for the processor to display a user interface on the display, the user interface comprising interactive user interface views, the display comprising a touchscreen, the touchscreen being operative to detect user touch inputs and to generate user input data from the user touch inputs, the processor being operatively connected to the touchscreen to read the user input data from the touchscreen;
the storage storing a plurality of albums, each of the albums being a logical entity stored in the storage, the logical entity being configured to logically contain zero or more digital media files stored in the storage, each of the albums having an album name comprising a string of characters;
the software application including instructions for the processor to:
when a digital file is added to an album, automatically assign to the file a filename stem comprising the album name.

2. The system of claim 1 further comprising the software application including instructions for the processor to:
designate one of the albums as a pinned album;
display a recording interface on the display, the recording interface comprising a record control;
on a first activation of the record control, activate the recording component to begin recording said audiovisual content to generate said digital media data when the record control is activated a first time by a user touch input on the touchscreen;
on a second activation of the record control, stop said recording and write to the storage a digital media file containing the digital media data generated during said recording; and
add the digital file to the pinned album.

3. The system of claim 1 wherein the software application further comprises instructions for the processor to, when a digital media file is moved from a first album into a second album, remove the album name of the first album from the filename stem of the moved digital media file.

4. The system of claim 1 wherein said instruction for the processor to automatically assign said filename stem comprising the album name being subject to the condition that the filename stem has not previously been edited by manual user input.

5. The system of claim 1 wherein said instruction for the processor to automatically assign said filename stem comprising the album name includes combining the album name with other characters.

6. The system of claim 5, wherein said other characters include characters manually entered by user input.

7. The system of claim 6 wherein the software application further comprises instructions for the processor to, when the digital media file in which said other characters include said manually entered characters is moved from a first album into a second album, remove the album name of the first album from, and add the album name of the second album to, the filename stem of the moved digital media file.

8. The system of claim 1 wherein the software application further comprises instructions for the processor to, when the album name of one of the albums is changed from an old album name to a new album name, automatically replace the old album name with the new album name in the filename stem of each digital media file contained in the album.

9. The system of claim 1 wherein the software application further comprises instructions for the processor, on receiving a user input instruction to transfer a digital media file that is contained in a first album and written to a first set of the physical memory locations to a second set of the physical memory locations without adding the digital media file to a second album, to cause the digital media file to be transferred to the second set of the physical memory locations while retaining the album name of the first album in its filename stem.
